(19) United States
(12) Patent Application Publication
(10) Pub. No.: US 2025/0080243 A1
(43) Pub. Date: Mar. 6, 2025

(54) MULTI-BAND OPERATION

(71) Applicant: Nokia Technologies Oy, Espoo (FI)

(72) Inventors: Bent Henneberg RYSGAARD, Aalborg (DK); Kim NIELSEN, Storvorde (DK); Stig BLÜCHER BRINK, Aalborg (DK); Feridoon JALILI, Gistrup (DK); Amol DHERE, Gistrup (DK)

(73) Assignee: Nokia Technologies Oy, Espoo (FI)

(21) Appl. No.: 18/817,483

(22) Filed: Aug. 28, 2024

(30) Foreign Application Priority Data
Sep. 1, 2023 (GB) 2313328.3

(51) Int. Cl. H04B 15/02; H04W 52/24

(52) U.S. Cl. CPC H04B 15/02; H04W 52/243

(57) ABSTRACT

A method, computer program and apparatus is described comprising: receiving, from a user equipment at a network node, an indication that the user equipment has the capability to mitigate self-interference at the user equipment for multi-band operation; and transmitting, from the network node to the user equipment, an approval to allow the user equipment to mitigate self-interference at the user equipment for the multi-band operation.

### FIELD

Example embodiments may relate to apparatus, methods and/or computer programs for multi-band operation and self-interference mitigation in mobile communication systems and the like.

### BACKGROUND

User devices, such as user equipment (UEs), that form part of a mobile communication system include transmitter and receiver modules. In some example embodiment, transmission and reception may be carried out at the same time. The remains a need for further development in this field.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

According to a first aspect, there is described a network node of a mobile communication system. The network node comprises means for receiving, from a user equipment, an indication that the user equipment has the capability to mitigate self-interference at the user equipment for multi-band operation and means for transmitting, to the user equipment, an approval to allow the user equipment to mitigate self-interference at the user equipment for the multi-band operation.

In some embodiments, the network node may comprise means for receiving, from the user equipment, at least one proposed parameter to be used for mitigating self-interference at the user equipment for the multi-band operation and means for determining the approval to allow the user equipment to mitigate self-interference at the user equipment for the multi-band operation based on the at least one proposed parameter.

In some embodiments, the at least one proposed parameter may comprise a safe transmit power level of the user equipment. The safe transmit power level may be a transmit power level of the user equipment below which self-interference would affect sensitivity of a receiver of the user equipment by no more than a threshold amount.

In some embodiments, the safe transmit power level may be determined based, at least in part, on a maximum sensitivity degradation value. The maximum sensitivity degradation value may be based, at least in part, on a configuration of the multi-band operation at the user equipment.

In some embodiments, the network node may comprise means for adjusting at least one of a primary component carrier and a secondary component carrier for the multi-band operation and means for transmitting a new approval to allow the user equipment to mitigate self-interference at the user equipment for the multi-band operation based on the adjusting.

In some embodiments, the network node may comprise means for adjusting the user equipment transmissions based on the approval.

In some embodiments, the network node may comprise means for adjusting timings of one or more uplink transmissions of the user equipment based on the approval.

In some embodiments, the approval comprises an automatic approval to allow the user equipment to mitigate self-interference at the user equipment.

According to a second aspect, there is described a user equipment of a mobile communication system. The user equipment comprises means for transmitting, to a network node, an indication that the user equipment has the capability to mitigate self-interference at the user equipment for multi-band operation and means for receiving, from the network node, an approval to allow the user equipment to mitigate self-interference at the user equipment for the multi-band operation.

In some embodiments, the user equipment may further comprise means for transmitting, to the network node, at least one proposed parameter to be used for mitigating self-interference at the user equipment for multi-band operation.

In some embodiments, the at least one proposed parameter may comprise a safe transmit power level of the user equipment. The safe transmit power level may be a transmit power of the user equipment below which self-interference would affect sensitivity of a receiver of the user equipment by no more than a threshold amount.

The safe transmit power level is determined based, at least in part, on a maximum sensitivity degradation value, and wherein the maximum sensitivity degradation value is based, at least in part, on a configuration of the multi-band operation at the user equipment.

In some embodiments, the at least one proposed parameter may comprise a transmit power level of the user equipment.

In some embodiments, the user equipment may further comprise means for controlling user equipment transmissions to mitigate self-interference at the user equipment.

In some embodiments, controlling said user equipment transmissions may include capping a transmit power level of the user equipment to a determined safe output power level in the event that it is determined that the safe output power level would be exceeded by implementing a transmit power control command received at the user equipment from the network node.

In some embodiments, controlling said user equipment transmissions may include asking permission from the network node to adjust timings of one or more uplink transmissions of the user equipment.

In some embodiments, controlling said user equipment transmission may include asking permission from the network node to control transmit power levels of said transmissions.

In some embodiments, controlling said user equipment transmission may include asking permission from the network node to prioritise between at least one primary component carrier and one secondary component carrier.

In some embodiments, the approval comprises an automatic approval to allow the user equipment to mitigate self-interference at the user equipment.

In some embodiments, for the node or user equipment the multi-band operation may be one of inter-band carrier aggregation, CA, operation or dual connectivity, DC, operation.

According to a third aspect, there is described a method comprising receiving, from a user equipment at a network node, an indication that the user equipment has the capability to mitigate self-interference at the user equipment for multi-band operation and transmitting, from the network node to the user equipment, an approval to allow the user equipment to mitigate self-interference at the user equipment for the multi-band operation.

According to a fourth aspect, there is described a method comprising transmitting, from a user equipment to a network node, an indication that the user equipment has the capability to mitigate self-interference at the user equipment for multi-band operation and receiving, at the user equipment from the network node, an approval to allow the user equipment to mitigate self-interference at the user equipment for the multi-band operation.

According to a fifth aspect, there is provided a computer program product comprising a set of instructions which, when executed on an apparatus, is configured to cause the apparatus to carry out the method of any preceding method definition.

According to a sixth aspect, there is provided a non-transitory computer readable medium comprising program instructions stored thereon for performing a method, comprising: receiving, from a user equipment at a network node, an indication that the user equipment has the capability to mitigate self-interference at the user equipment for multi-band operation and transmitting, from the network node to the user equipment, an approval to allow the user equipment to mitigate self-interference at the user equipment for the multi-band operation.

According to a sixth aspect, there is provided a non-transitory computer readable medium comprising program instructions stored thereon for performing a method, comprising transmitting, from a user equipment to a network node, an indication that the user equipment has the capability to mitigate self-interference at the user equipment for multi-band operation and receiving, at the user equipment from the network node, an approval to allow the user equipment to mitigate self-interference at the user equipment for the multi-band operation.

### BRIEF DESCRIPTION OF THE DRAWINGS

Example embodiments will now be described by way of non-limiting example, with reference to the accompanying drawings, in which:

FIG. 1 is a flowchart showing a network structure in accordance with an example embodiment;

FIG. 2 is a block diagram showing output power in accordance with an example embodiment;

FIG. 3 is a block diagram showing input power in accordance with an example embodiment;

FIG. 4 is a plot demonstrating examples of interference in accordance with an example embodiment;

FIG. 5 is a message flow sequence in accordance with an example embodiment;

FIG. 6 is a flowchart showing an algorithm in accordance with an example embodiment;

FIG. 7 is a block diagram demonstrating aspects of the algorithm of FIG. 6;

FIG. 8 is a block diagram of a system in accordance with an example embodiment;

FIG. 9 is a flowchart of a method in accordance with an example embodiment;

FIG. 10 is a flowchart of a method in accordance with an example embodiment;

FIG. 11 is a message flow sequence in accordance with a first example embodiment;

FIG. 12 is a message flow sequence in accordance with a second example embodiment;

FIG. 13 is a message flow sequence in accordance with a third example embodiment;

FIG. 14 is a message flow sequence in accordance with a fourth example embodiment;

FIG. 15 is a message flow sequence in accordance with a fifth example embodiment;

FIG. 16 is a schematic diagram of components of one or more of the example embodiments described previously; and

FIG. 17 shows tangible media for storing computer-readable code which when run by a computer may perform methods according to example embodiments described herein.

### DETAILED DESCRIPTION

The scope of protection sought for various embodiments of the invention is set out by the independent claims. The embodiments and features, if any, described in the specification that do not fall under the scope of the independent claims are to be interpreted as examples useful for understanding various embodiments of the invention.

In the description and drawings, like reference numerals refer to like elements throughout.

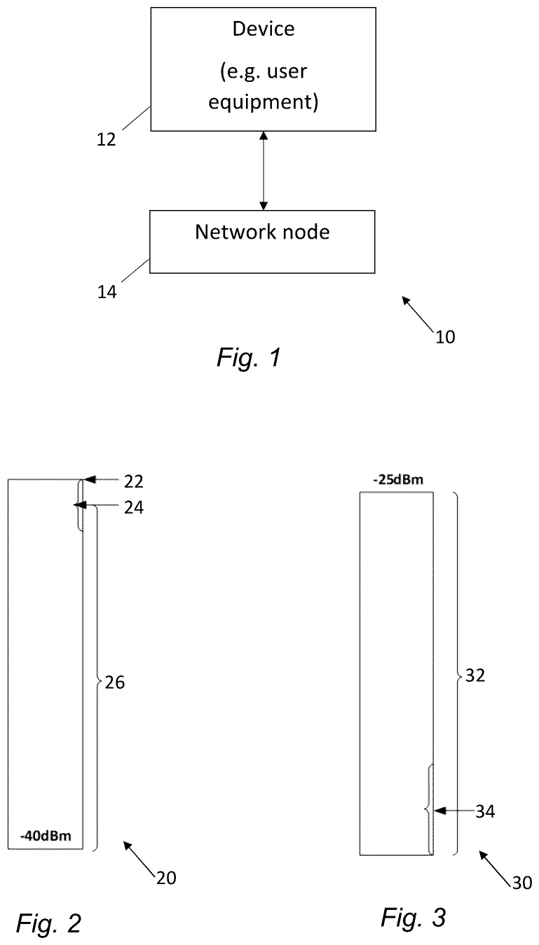

FIG. 1 is a network architecture of a telecommunication system, indicated generally by the reference numeral 10, in accordance with an example embodiment. A device 12 such as a user device or a user equipment (UE) of a mobile communication system is shown as being connected to a network node 14. As used herein, the device 12 may comprise a user device. The user device may be a portable user device, for example a smartphone, laptop, consumer devices, sensors, robots, vehicles, aerial vehicles, drones, tablet computer, digital assistant, wearable computer or head mounted device (HMD). This list is not exhaustive. As used herein a network node 14 may be radio access network, RAN, base stations, such as gNB (5G/NR) or eNB (4G/LTE) or wireless access point

The network architecture may, for example, seek to address a self-interference impact of the device as a result of a carrier aggregation (CA) or a dual connectivity (DC) configuration of the device.

FIG. 2 is a block diagram showing output power, indicated generally by the reference numeral 20, in accordance with an example embodiment.

FIG. 3 is a block diagram showing input power, indicated generally by the reference numeral 30, in accordance with an example embodiment.

The block diagram 20 relates to transmit power of a device (such as the device 10 referred to in the FIG. 1). Similarly, the block diagram 30 relates to received power of a device (such as the device 10 referred to in FIG. 1).

The block diagram 20 shows two different maximum power levels. A first, higher, maximum power level 22 is a maximum power level that can be delivered by the device in accordance with the relevant standard (e.g. 3GPP standard; thus the first maximum power level 22 may be referred to as 3GPP Pₘₐₓ). A second, lower, maximum power level 24 is the maximum output power that the respective device can deliver in accordance with the principles described herein. The second maximum power level 24 is lower than the first maximum power level by an amount based on a maximum sensitivity degradation (MSD) of the device (as discussed in detail below). The second maximum power range 24 is referred to herein is Pₘₐₓ.

The block diagram 20 shows a power range 26, which is an operational power range of the device. That power range is capped at the second maximum power level 24 (Pₘₐₓ).

The block diagram 30 include a power range 32 of the receiver of the device. A portion 34 of the receiver power relates to the MSD value, which defines an allowed relaxation of a reference sensitivity of the receiver due to self-interference as a result of concurrent transmissions of the device (e.g. in carrier aggregation or dual connectivity configurations).

MSD can therefore be viewed as a reduction from the UE reference sensitivity that shifts this level upwards to a higher minimum reference sensitivity level. Note that there is not necessarily a 1:1 relation between the output power level 20 that causes self-interference to degrade the reference sensitivity and the MSD value in the input power level 30 that relaxes the requirement to the reference sensitivity. The relation depends, for example, on the MSD type (as discussed further below).

The relation between the output (Tx) power of the device in the presence of an MSD type for a given band combination to the level of sensitivity degradation is known through the agreed MSD values captured in the specifications of 3GPP including the MSD type. Since this relation is known, the device may contain data information about the MSD affected carrier aggregation (CA) cases (a list of CA combinations) and their fallbacks that allows the device to determine the MSD level expected for a CA configuration.

The MSD value can be translated through the MSD type into the output power (Pₘₐₓ) that would cause self-interference. A device (e.g. a UE) can use this information to seek to mitigate self-interference as discussed in detail below.

There are different types of signal sources in the device output that may lead to relaxation through Maximum Sensitivity Degradation (MSD), but they may be regarded as belonging to two different groups. In a first group, only one uplink (UL) component carrier is configured in a carrier aggregation band combination. In a second group, two uplink (UL) component carriers are configured.

The first group includes uplink harmonics, harmonic mixing and cross-band distortion. The second group includes inter-modulation distortion (IMD). These are discussed further below.

Uplink (UL) harmonics may cause self-interference in the other downlink (DL) component carrier(s) as a result of one or more harmonics of the uplink component carrier (CC) falling inside the other DL component carrier bandwidth.

Harmonic mixing may cause self-interference when a combination of the UL harmonics coincides with the DL harmonics of the other DL component.

Cross band distortion is an expression of self-interference when the output spectrum of the UL component carrier falls inside the DL component carrier bandwidth.

Inter-Modulation Distortion (IMD) occurs when two UL component carriers inter-modulate (mix) and the product of the mixing of the UL component carriers fall inside the receiver band of one or the other DL component carrier bandwidth.

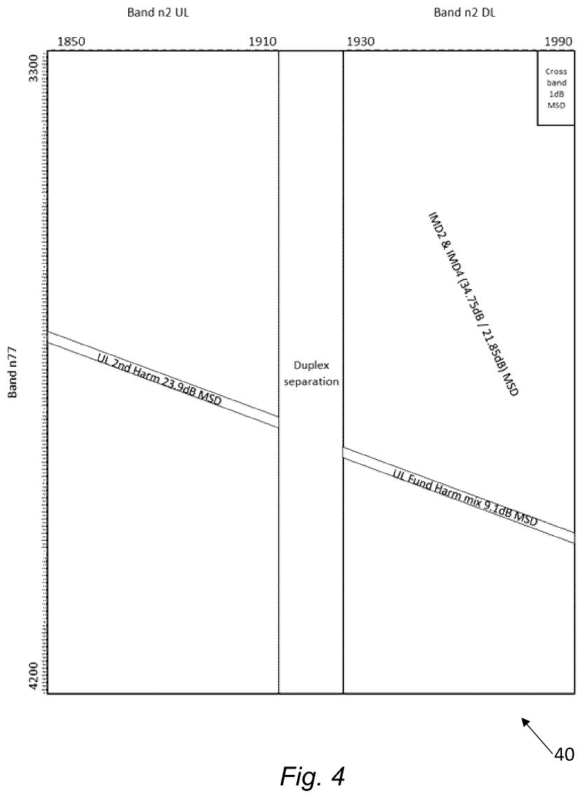

FIG. 4 is a plot, indicated generally by the reference numeral 40, demonstrating examples of interference in accordance with an example embodiment.

FIG. 4 shows a particular carrier aggregation configuration (CA_n2-n77) where the y-axis is the n77 TDD channel allocation and the x-axis is the n2 FDD channel allocation for UL and DL respectively. Depending on the channel allocation within the two operational bands, occurrences of all four types of MSD discussed above are possible. Note that the four types are specified with different MSD values, with IMD2 having the highest MSD value (34.75 dB) and cross-band having the lowest MSD (1 dB).

The level of self-interference at the device is design-specific and implementation-specific. Many advances in UE front-end and transmitter and receiver designs have been developed that have improved self-interference suppression. In general terms, the relationship (or ratio) between the device output power and the self-interference depends on the MSD type.

Some of the MSD types have an uplink/downlink relation of 1 dB to 1 dB, which means that 1 dB increase in TX output power of the UE results in a 1 dB increase in the self-interference level, which degrades the UE sensitivity by 1 dB. In other MSD types this relationship follows the order of the product that generates the self-interference, as the example case of second harmonic of the TX falling inside the RX victim band will have a relation of 1 dB to 2 dB, which means that 1 dB increase of TX output power results in 2 dB increase to the power level of the second harmonic (so that the sensitivity of the RX victim receive band reduces by 2 dB for every 1 dB increase in TX output power).

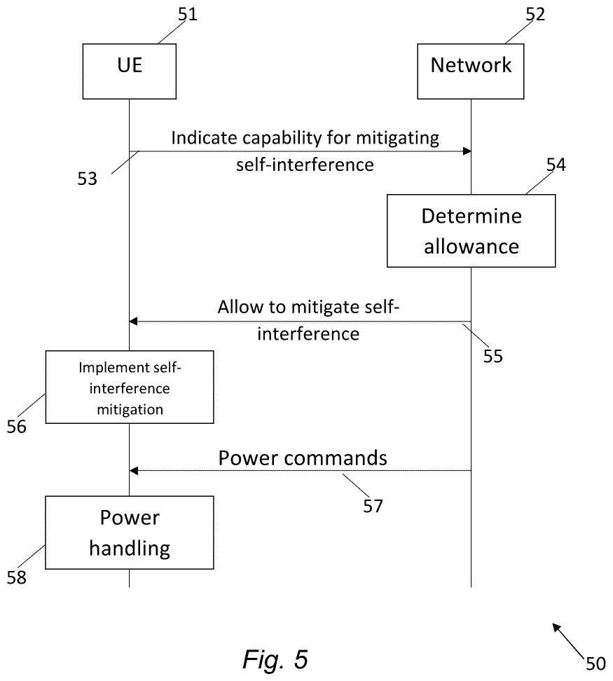

FIG. 5 is a message flow sequence, indicated generally by the reference numeral 50, in accordance with an example embodiment. The sequence 50 shows messages between a user equipment (UE) 51 and a network node 52.

In message 53, the UE 51 provides an indication to the network node 52 that the UE 51 has the capability to mitigate self-interference at the user equipment for multi-band operation. Based, at least in part, on capability data provided by the UE 51, the network 52 determines whether to allow the UE to mitigate self-interference at the user equipment itself (at step 54) and provides that allowance to the UE 51 in message 55. The self-interference mitigation is then implemented at the UE 51 in step 56.

The UE 51 further receives transmit power commands 57 from the network node 52. The UE 51 implements a power handling algorithm in step 58 based on the transmit power commands 57 and based on a Pₘₐₓ value, as discussed in detail below.

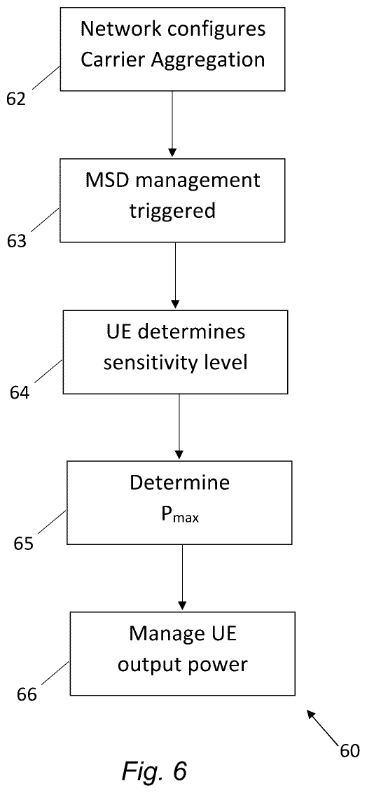

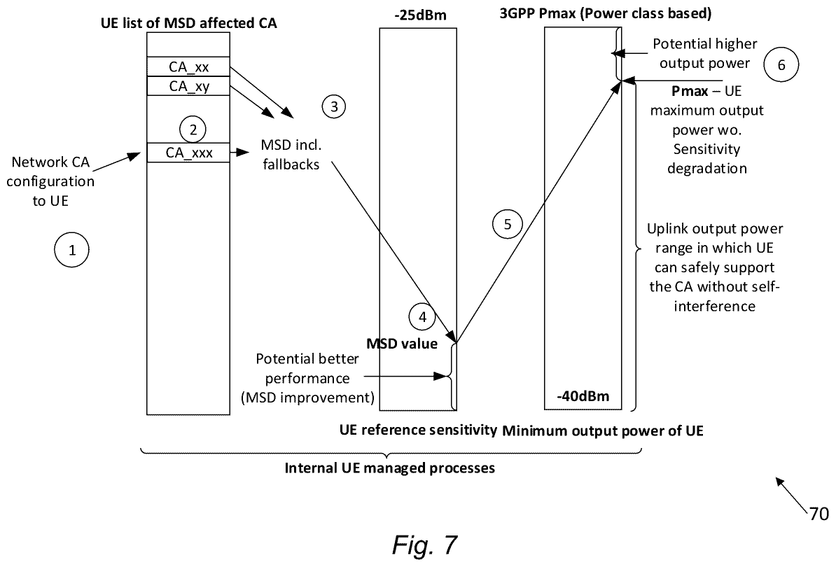

FIG. 6 is a flowchart showing an example algorithm used by the UE to mitigate self-interference at the UE, indicated generally by the reference numeral 60, in accordance with an example embodiment. The example algorithm shown in FIG. 6 is one method for carrying out mitigation of self-interference at a UE, although other known methods may conceivably be used. FIG. 7 is a block diagram, indicated generally by the reference numeral 70, demonstrating aspects of the algorithm 60 shown in FIG. 6.

The algorithm 60 starts at operation 62, where the relevant network node (e.g. the network node 52 of the message flow sequence 50) configures an MSD affected CA. This is shown on the left hand side of the block diagram 70 (see indicator 1).

At step 63 of the algorithm 60, MSD management is triggered. As shown in the block diagram 70, the UE includes a list of MSD-affected carrier aggregation combinations. In the operation 63, the UE (e.g. the UE 51 of the message flow sequence 50) checks the data it has regarding the carrier aggregation configured in operation 62 and its fallbacks.

From the data of the MSD values, the UE knows what level of sensitivity to expect from the CA. Thus, the sensitivity level is determined in the operation 64 of the algorithm 60 (see indicator 4 in the block diagram 70).

At operation 65, the MSD value determined in the operation 64 is used to determine Pₘₐₓ (the maximum output power of the UE without sensitivity degradation)—see indicator 6 in the block diagram 70.

Finally, at operation 66, the UE manages its output power by limiting its transmission power intelligently (thereby implementing operation 58 of the algorithm 50).

The operation 66 may be implemented in different ways, some of which are discussed in detail below. For example, the UE may limit UL power by looking at UL and DL scheduling, slot configuration (control, data symbols) as well carrier configuration (primary CC vs. secondary CC). The UE may limit UL power until it has determined that the level of self-interference is less than what the pre-determined data indicates. By limiting the UE output power, the UE can seek to ensure (without network involvement) that the CA configuration will not cause a transmission of output power that would degrade and potentially exceed the input signal level of the RX victim receive band. After CA configuration grant, operating at the limited output power the UE will gradually learn if it may increase the Pₘₐₓ based on observations/measurements/determination of its own level of self-interference in the RX victim band.

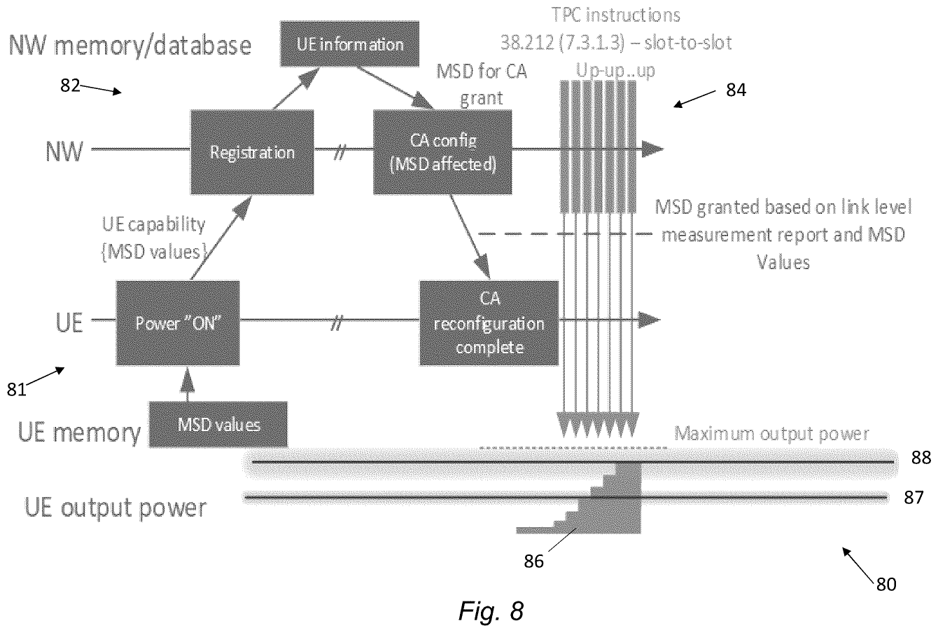

FIG. 8 is a block diagram of a system, indicated generally by the reference numeral 80, in accordance with an example embodiment. The system 80 includes a UE, indicated generally by the reference numeral 81 and a network node, indicated generally by the reference numeral 82. The UE 81 and the network node 82 are similar to the UE 51 and the network node 52 described above.

The UE 81 has a memory for storing MSD values and the network node 82 has a memory storing UE information. The network node sets a CA configuration that is provided to the UE. The UE then implements a self-interference avoidance mechanism as discussed further below.

In the system 80, the UE receives Transmit Power Control (TPC) commands, indicated generally by the reference numeral 84, from the network 82. In this simple example, each of the TPC commands 84 requests that the UE output power is increased (i.e. the commands are “Up” commands).

An output power of the UE is shown by the power output 86. The power output 86 is generated in response to the TPC instructions 84. As shown in the power output 86, the output power increases in response to each “Up” TPC command, with that power being forced beyond the output power limit 87 that identifies with the allowed MSD value covered by the 3GPP specification 38.101, since there is no regulatory requirement prohibiting the NW from doing so. The UE will follow the TPC requests until it reaches the determined maximum output power (Pₘₐₓ) at which the self-interference is just tolerated (as indicated by the power level 88), thereby enabling the UE to show improved performance over the 3GPP specifications, but at the same time taking control to mitigate impacts of surpassing the limit 87. Any TPC “up” instruction from here is disregarded, since the Pₘₐₓ limit inside the UE takes effect. It is worth mentioning that this is not a violation of the relevant 3GPP standard, since the UE already has shown better performance than the requirements for UE approval of 38.101. So, all the UE does is to transmit with no more output power than can be tolerated, while the UE ensures the self-interference does not cause a call drop.

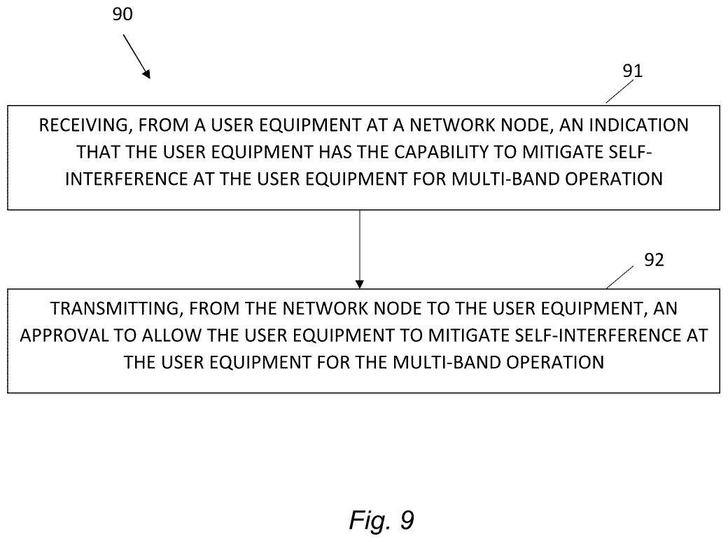

FIG. 9 shows, by way of example, a flowchart of a method according to example embodiments. Each element of the flowchart may comprise one or more operations. The operations may be performed in hardware, software, firmware or a combination thereof. For example, the operations may be performed, individually or collectively, by a means, wherein the means may comprise at least one processor; and at least one memory storing instructions that, when executed by the at least one processor, cause the performance of the operations.

The method 90 comprises a first operation 91 of receiving, from a UE at a network node, an indication that the UE has the capability to mitigate self-interference at the UE for multi-band operation. The multi-band operation may be one of inter-band carrier aggregation, CA, operation or dual connectivity, DC, operation.

The method 90 comprises a second operation 92 of transmitting, from the network node to the UE, an approval to allow the UE to mitigate self-interference at the UE for the multi-band operation.

The method 90 is performed by a network node, such as the network node 52 of FIG. 5.

The method 90 may further comprise receiving, from the UE, at least one proposed parameter to be used for mitigating self-interference at the UE for the multi-band operation. The proposed parameter may comprise a safe transmit power level of the UE, wherein said safe transmit power level is a transmit power level of the UE below which self-interference would affect sensitivity of a receiver of the UE by no more than a threshold amount. The safe transmit power level may be equivalent to Pₘₐₓ as previously define above. This means that the safe transmit power level may be determined based, at least in part, on the maximum sensitivity degradation (MSD) value, which is itself based, at least in part, on a configuration of the multi-band operation at the UE.

The at last one proposed parameter could also be a current power transmit level of the UE which may be used by the network node to inform the decision of whether to allow the UE to mitigate self-interference at the UE.

The method 90 may further comprise determining the approval to allow the UE to mitigate self-interference at the UE for the multi-band operation based on the at least one proposed parameter. In other words, the network node may determine whether to allow the UE to mitigate self-interference at the UE for the multi-band operation based on the Pₘₐₓ value determined by the UE.

The method 90 may further comprise adjusting at least one of a primary component carrier and a secondary component carrier for the multi-band operation and transmitting a new approval to allow the UE to mitigate self-interference at the UE for the multi-band operation based on the adjusting. The new approval may be required due to the adjustment of a primary component carrier or the second component carrier already present, or due to the introduction of an entirely new component carrier that was not present previously. The new approval to allow the UE to mitigate self-interference may be needed each time an adjustment is made. This ensures the network node remains in control of the self-interference mitigation conducted by the UE.

The method 90 may include the network node adjusting the UE transmissions, for instance on a slot-to-slot basis, and/or adjusting timings of one or more uplink transmissions of the UE based on the approval.

In some scenarios the approval to allow the UE to mitigate self-interference at the UE may comprise an automatic approval. In this instance, limited decision making is needed at the network node as a simple allow communication is notified.

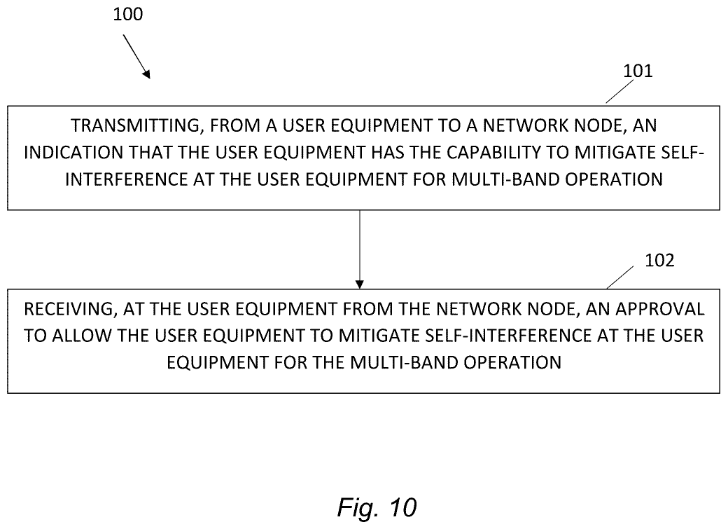

FIG. 10 shows, by way of example, a flowchart of a method according to example embodiments. Each element of the flowchart may comprise one or more operations. The operations may be performed in hardware, software, firmware or a combination thereof. For example, the operations may be performed, individually or collectively, by a means, wherein the means may comprise at least one processor; and at least one memory storing instructions that, when executed by the at least one processor, cause the performance of the operations.

The method 100 comprises a first operation 101 of transmitting, from a UE to a network node, an indication that the UE has the capability to mitigate self-interference at the UE for multi-band operation.

The method 100 comprises a second operation 102 of receiving, at the UE from the network node, an approval to allow the UE to mitigate self-interference at the UE for the multi-band operation.

The method 100 is performed by a device such as a UE, for example, the UE 51 of FIG. 5.

In some scenarios the approval to allow the UE to mitigate self-interference at the UE may comprise an automatic approval from the network node.

Alternatively, the method 100 may further comprise transmitting, to the network node, at least one proposed parameter (as discussed above) to be used for mitigating self-interference at the UE for multi-band operation. The proposed parameter is received by the network node as discussed above.

The method 100 may further comprise controlling user equipment transmissions to mitigate self-interference at the user equipment. Controlling user equipment transmissions includes capping a transmit power level of the user equipment to the determined safe output power level (Pₘₐₓ) in the event that it is determined that the safe output level would be exceeded by implementing a transmit power command received at the user equipment from the network node. This process may occur according to the example algorithm used by the UE to mitigate self-interference at the UE shown in FIG. 6.

Furthermore, controlling said UE transmissions may include asking permission by the UE from the network node to adjust timings of one or more uplink transmissions of the UE, and/or to control transmit power levels of said transmissions, for example on a slot-to-slot basis, and/or to prioritize between at least one primary component carrier and one secondary component carrier. The network node may approve or reject each of these requests by the UE.

By virtue of the methods 90, 100 discussed in FIG. 9 and FIG. 10 the UE does not need to exchange the huge list of data about MSD types, values, orders, but rather it can inform the network about potential self-managed MSD at connection setup, after the UE knows the exact channel configuration. The network node will signal an approval to the UE for self-managed MSD if the network desires this mode of operation. The approval can be a single bit or multiple bits for each uplink channel (e.g. 1 bit for PUSCH, 1 bit for PUCCH, 1 bit for SRS).

This configuration allows the UE capability signaling to make MSD affected CA control faster and means the UE uses the new capability of self-managed output power control in MSD affected CA cases. Furthermore, this configuration allows the UE to resolve output power control issues on a slot-to-slot basis and therefore provides a fast way of mitigating self-interference at the UE. The UE doesn't require the network to assist in determining the MSD of the UE and the UE doesn't need to exchange MSD values and MSD types with the network, thereby reducing the amount of information that needs to be sent to the network node for a decision to make as to whether the UE is allowed to mitigate self-interference.

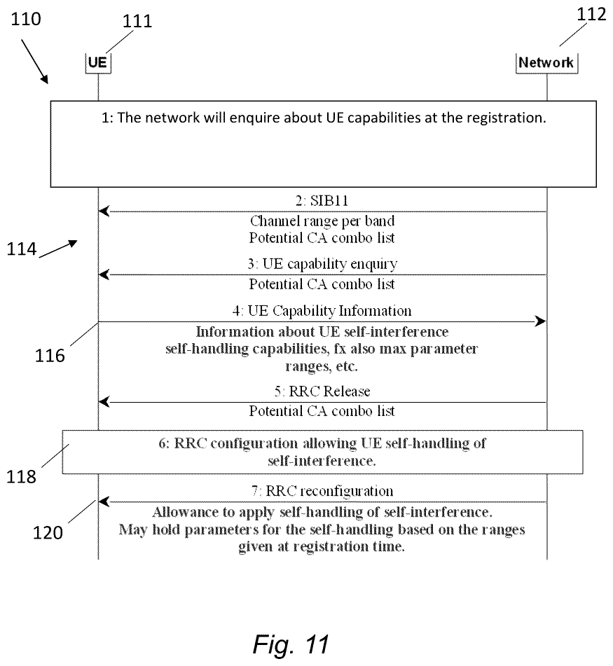

FIG. 11 is a message flow sequence, indicated generally by the reference numeral 110, in accordance with an example embodiment. The sequence 110 shows messages between a UE 11 (such as the UE 51 described above) and a network node 112 (such as the network node 52 described above). The sequence 110 shows the UE 111 reacting to network messaging and initiating the processes for self-managed MSD at the UE.

Following setup and configuration sequence indicated generally by the reference numeral 114, the UE 111 sends an indication 116 that the user equipment has the capability to mitigate self-interference at the UE for multi-band operation. The indication may include a specific request for the capability to mitigate self-interference at the UE 111. The indication also includes the at least one proposed parameter which is proposed by the UE 111 (e.g. the proposed Pₘₐₓ). At step 118 the network node makes a decision about whether to allow the UE 11 to handle self-interference. As shown in the FIG. 11. this may be a simple allowance. At step 120 the network node 112 sends the approval to allow the UE 111 to mitigate self-interference at the UE 111 for the multi-band operation. The allowance may include specific suggested parameters from the network node 112 based on the at least one parameter received by the network node 112.

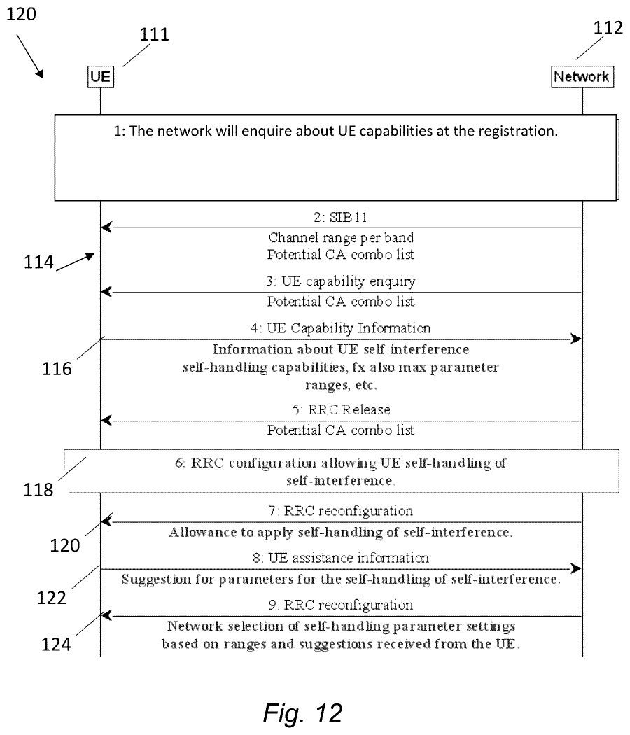

FIG. 12 is a message flow sequence, indicated generally by the reference numeral 120, in accordance with an example embodiment. The sequence 120 shows messages between a UE 111 (such as the UE 51 described above) and a network node 112 (such as the network node 52 described above). The sequence 120 shows the UE 111 reacting to network messaging and initiating the processes for self-managed MSD at the UE. Like reference numerals of FIG. 12 show the same steps as described above in relation to FIG. 11.

After receiving the allowance at step 120, the UE may transmit at least one suggested parameter for use in the mitigation of the self-interference at the UE 111 (step 122). This may be done alongside RRC configuration. Optionally, the network can then either accept the suggestion, reject or adjust the parameters suggested by the UE (step 124). This is static for the RRC configuration.

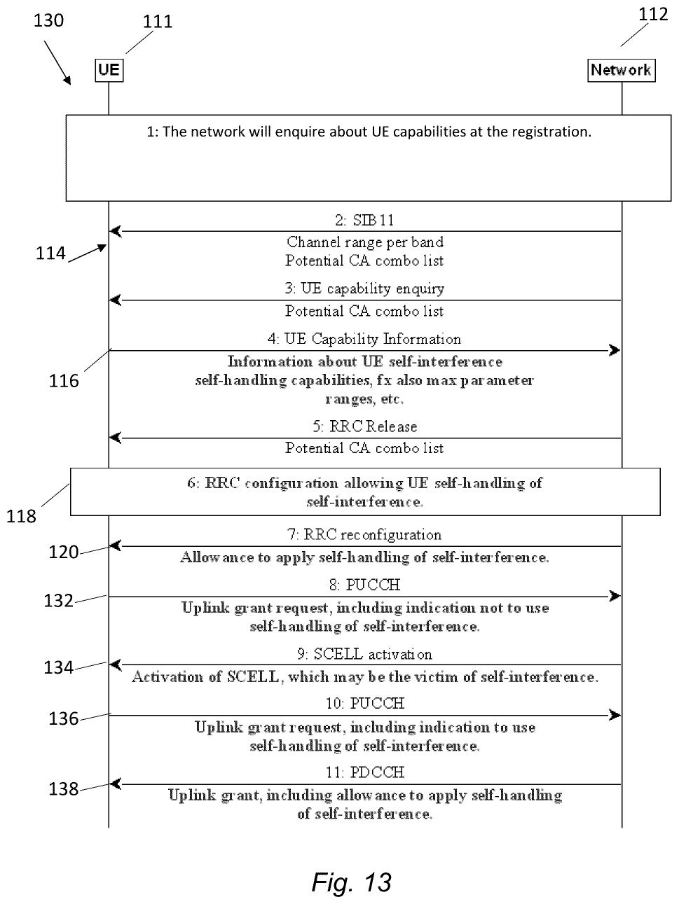

FIG. 13 is a message flow sequence, indicated generally by the reference numeral 130, in accordance with an example embodiment. The sequence 130 shows messages between a UE 111 (such as the UE 51 described above) and a network node 112 (such as the network node 52 described above). The sequence 130 shows the UE 111 reacting to network messaging and initiating the processes for self-managed MSD at the UE. Like reference numerals of FIG. 13 show the same steps as described above in relation to FIG. 11 and FIG. 12.

New steps 132 to 138 are shown in FIG. 13. At step 132, the UE 111 requests uplink resources from the network node 112 and at the same time indicates that the UE does not need to apply mitigation for MSD. This means that the UE will, for example, apply the commanded output power without any reduction since there is no risk of the Pₘₐₓ being exceeded. At step 134, a secondary component carrier is activated, by way of example, will suffer from self-interference. Therefore, the UE 111 will indicate through PUCCH (or through another UL channel) that it will apply for self-handling of self-interference.

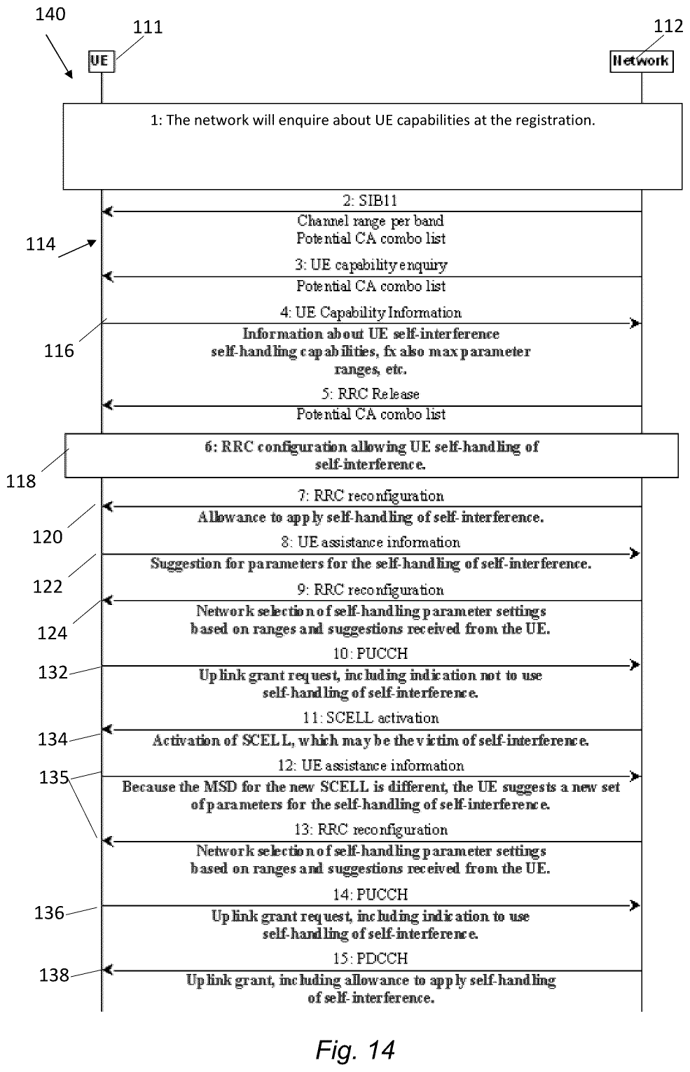

Few scenarios can now occur (as denoted by 135 in FIG. 14):
1. The network node 112 can determine that the UE 111 uplink power shall be maintained. In this case, there can be two outcomes:
   a. The network node 112 can reduce the coding of DL during the uplink transmission from the UE 111 to mitigate the self-interference.
   b. Or no action is taken by the network node 111.
2. The network node 112 can allow the reduction in UE 111 output power in the grant. Again, in this case, there can be two outcomes:
   a. The network node 112 can maintain the coding and apply network side only interference mitigation techniques.
   b. The network node 112 can reduce the coding of the uplink grant to compensate for the reduced uplink power.
3. The network node 112 can start time multiplexing the uplink and downlink grants so that self-interference is mitigated by the uplink and downlink resources not colliding in time, thereby avoiding MSD.

In each of these scenarios, UE 111 has given the network node 112 the information that an MSD situation is about to occur in step 136. This may be in almost real-time e.g. when sent via PUCCH. The network node 112 may send back an allowance to apply the mitigation of self-interference at the UE 111. With this solution, any change in radio resources can change the UE behavior in handling of self-interference.

The UE 111 may ask permission from the network node to prioritize between at least one primary component carrier and one secondary component carrier and the network node 112 may adjust at least one of a primary component carrier and a secondary component carrier for the multi-band operation and transmit a new approval to allow the UE 111 to mitigate self-interference at the user equipment for the multi-band operation based on the adjusting.

The UE 111 may ask permission from the network node 112 to control power levels of said transmissions, for example on a slot-to-slot basis, and in response the network node 112 may provide means for adjusting the UE 111 transmissions, for example on a slot-to-slot, basis based on an approval by the network node 112.

The UE 111 may ask permission from the network node 112 to adjust timings of one or more uplink transmissions of the user equipment and in response the network node 112 may provide means for adjusting the timings of one or more uplink transmissions of the user equipment.

FIG. 14 is a message flow sequence, indicated generally by the reference numeral 140, in accordance with an example embodiment. The sequence 140 shows messages between a UE 111 (such as the UE 51 described above) and a network node 112 (such as the network node 52 described above). The sequence 140 shows the UE 111 reacting to network messaging and initiating the processes for self-managed MSD at the UE. Like reference numerals of FIG. 14 show the same steps as described above in relation to FIG. 11, FIG. 12 and FIG. 13. FIG. 14 shows the combination of steps of both FIGS. 12 and 13 within the same sequence and shows that the steps described above in relation to FIG. 12 and FIG. 13 may be combined.

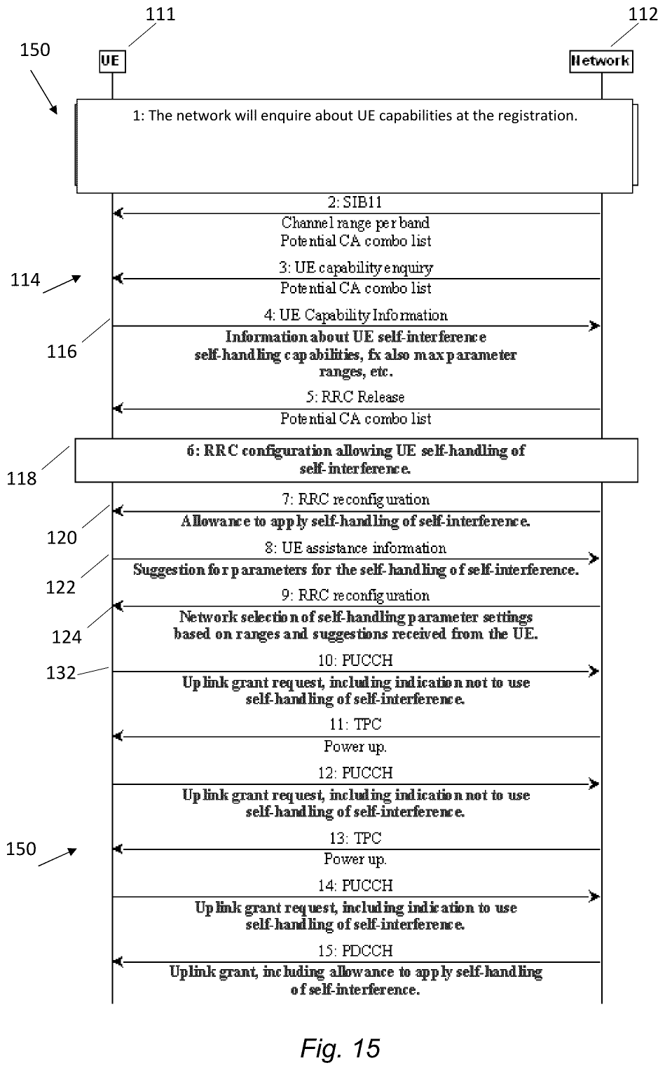

FIG. 15 is a message flow sequence, indicated generally by the reference numeral 150, in accordance with an example embodiment. The sequence 150 shows messages between a UE 111 (such as the UE 51 described above) and a network node 112 (such as the network node 52 described above). The sequence 150 shows the UE 111 reacting to network messaging and initiating the processes for self-managed MSD at the UE. Like reference numerals of FIG. 14 show the same steps as described above in relation to FIGS. 11 to 14.

FIG. 15 shows how the UE will start to indicate the need mitigation of MSD when the UE output power exceeds a pre-determined threshold measured or estimated to cause MSD (generally denoted by 150 in FIG. 15). The power commands may be via TPC. This demonstrates that mitigation is only applied when self-interference is really occurring or due to occur at the UE 111, not as a fixed configuration for the duration of the RRC configuration.

An alternative solution could be to use MAC-CE (medium access control-control element) messages to indicate the start and stop mitigation of self-interference. In this case, the MAC-CE could even hold parameters, thereby cancelling the need for RRC signaling.

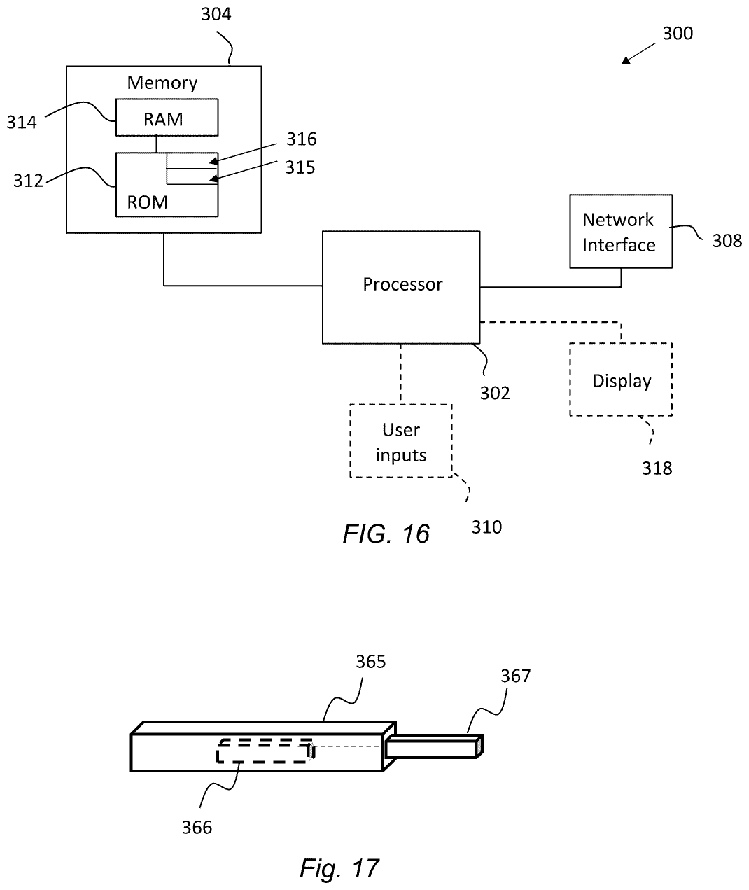

For completeness, FIG. 16 is a schematic diagram of components of one or more of the example embodiments described previously, which hereafter are referred to generically as a processing system 300. The processing system 300 may, for example, be the apparatus referred to in the claims below.

The processing system 300 may have a processor 302, a memory 304 closely coupled to the processor and comprised of a RAM 314 and a ROM 312, and, optionally, a user input 310 and a display 318. The processing system 300 may comprise one or more network/apparatus interfaces 308 for connection to a network/apparatus, e.g. a modem which may be wired or wireless. The network/apparatus interface 308 may also operate as a connection to other apparatus such as device/apparatus which is not network side apparatus. Thus, direct connection between devices/apparatus without network participation is possible.

The processor 302 is connected to each of the other components in order to control operation thereof.

The memory 304 may comprise a non-volatile memory, such as a hard disk drive (HDD) or a solid state drive (SSD). The ROM 312 of the memory 304 stores, amongst other things, an operating system 315 and may store software applications 316. The RAM 314 of the memory 304 is used by the processor 302 for the temporary storage of data. The operating system 315 may contain code which, when executed by the processor implements aspects of the algorithms and sequences 10, 50, 60, 90, 100, 110, 120, 130, 140 and 150 described above. Note that in the case of small device/apparatus the memory can be most suitable for small size usage i.e. not always a hard disk drive (HDD) or a solid state drive (SSD) is used.

The processor 302 may take any suitable form. For instance, it may be a microcontroller, a plurality of microcontrollers, a processor, or a plurality of processors.

The processing system 300 may be a standalone computer, a server, a console, or a network thereof. The processing system 300 and needed structural parts may be all inside device/apparatus such as IoT device/apparatus i.e. embedded to very small size.

In some example embodiments, the processing system 300 may also be associated with external software applications. These may be applications stored on a remote server device/apparatus and may run partly or exclusively on the remote server device/apparatus. These applications may be termed cloud-hosted applications. The processing system 300 may be in communication with the remote server device/apparatus in order to utilize the software application stored there.

FIG. 17 shows a tangible media, in the form of a removable memory unit 365, storing computer-readable code which when run by a computer may perform methods according to example embodiments described above. The removable memory unit 365 may be a memory stick, e.g. a USB memory stick, having internal memory 366 storing the computer-readable code. The internal memory 366 may be accessed by a computer system via a connector 367. Of course, other forms of tangible storage media may be used, as will be readily apparent to those of ordinary skilled in the art. Tangible media can be any device/apparatus capable of storing data/information which data/information can be exchanged between devices/apparatus/network.

Embodiments of the present invention may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any non-transitory media or means that can contain, store, communicate, propagate or transport the instructions for use by or in connection with an instruction execution system, apparatus, or device, such as a computer.

Reference to, where relevant, “computer-readable medium”, “computer program product”, “tangibly embodied computer program” etc., or a “processor” or “processing circuitry” etc. should be understood to encompass not only computers having differing architectures such as single/multi-processor architectures and sequencers/parallel architectures, but also specialised circuits such as field programmable gate arrays FPGA, application specify circuits ASIC, signal processing devices/apparatus and other devices/apparatus. References to computer program, instructions, code etc. should be understood to express software for a programmable processor firmware such as the programmable content of a hardware device/apparatus as instructions for a processor or configured or configuration settings for a fixed function device/apparatus, gate array, programmable logic device/apparatus, etc.

If desired, the different functions discussed herein may be performed in a different order and/or concurrently with each other. Furthermore, if desired, one or more of the above-described functions may be optional or may be combined. Similarly, it will also be appreciated that the flow diagrams and sequences of FIGS. 1, 5, 6 and 9 to 15 are examples only and that various operations depicted therein may be omitted, reordered and/or combined.

It will be appreciated that the above-described example embodiments are purely illustrative and are not limiting on the scope of the invention. Other variations and modifications will be apparent to persons skilled in the art upon reading the present specification.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

Although various aspects of the invention are set out in the independent claims, other aspects of the invention comprise other combinations of features from the described example embodiments and/or the dependent claims with the features of the independent claims, and not solely the combinations explicitly set out in the claims.

It is also noted herein that while the above describes various examples, these descriptions should not be viewed in a limiting sense. Rather, there are several variations and modifications which may be made without departing from the scope of the present invention as defined in the appended claims.

1. A network node of a mobile communication system,
the network node comprising:
at least one processor; and
at least one memory
storing instructions that, when executed by the at least one processor, cause the node at least to:
receive, from a user equipment, an indication that the user equipment has the capability to mitigate self-interference at the user equipment for multi-band operation; and
transmit, to the user equipment, an approval to allow the user equipment to mitigate self-interference at the user equipment for the multi-band operation.

2. The network node of claim 1, further comprising wherein the node is caused to:
receive, from the user equipment, at least one proposed parameter to be used for mitigating self-interference at the user equipment for the multi-band operation; and
determine the approval to allow the user equipment to mitigate self-interference at the user equipment for the multi-band operation based on the at least one proposed parameter.

3. The network node of claim 2, wherein the at least one proposed parameter comprises a safe transmit power level of the user equipment,
and wherein said safe transmit power level is a transmit power level of the user equipment below which self-interference would affect sensitivity of a receiver of the user equipment by no more than a threshold amount.

4. The network node of claim 3, wherein the safe transmit power level is determined based, at least in part, on a maximum sensitivity degradation value,
and wherein the maximum sensitivity degradation value is based, at least in part, on a configuration of the multi-band operation at the user equipment.

5. The network node of claim 1, wherein the node is caused to:
adjust at least one of a primary component carrier and a secondary component carrier for the multi-band operation; and
transmit a new approval to allow the user equipment to mitigate self-interference at the user equipment for the multi-band operation based on the adjusting.

6. The network node of claim 1, wherein the node is caused to:
adjust the user equipment transmissions based on the approval.

7. The network node of claim 1, wherein the node is caused to:
adjust timings of one or more uplink transmissions of the user equipment based on the approval.

8. (canceled)

9. A user equipment of a mobile communication system,
the user equipment comprising:
at least one processor; and
at least one memory
storing instructions that, when executed by the at least one processor, cause the user equipment at least to:
transmit, to a network node, an indication that the user equipment has the capability to mitigate self-interference at the user equipment for multi-band operation; and
receive, from the network node, an approval to allow the user equipment to mitigate self-interference at the user equipment for the multi-band operation.

10. The user equipment of claim 9, wherein the user equipment is caused to:
transmit, to the network node, at least one proposed parameter to be used for mitigating self-interference at the user equipment for multi-band operation.

11. The user equipment of claim 10, wherein the at least one proposed parameter comprises a safe transmit power level of the user equipment,
and wherein said safe transmit power level is a transmit power of the user equipment below which self-interference would affect sensitivity of a receiver of the user equipment by no more than a threshold amount.

12. The user equipment of claim 11, wherein the safe transmit power level is determined based, at least in part, on a maximum sensitivity degradation value, and wherein the maximum sensitivity degradation value is based, at least in part, on a configuration of the multi-band operation at the user equipment.

13. The user equipment of claim 10, wherein the at least one proposed parameter comprises a transmit power level of the user equipment.

14. The user equipment of claim 9, wherein the user equipment is caused to:
control user equipment transmissions to mitigate self-interference at the user equipment.

15. The user equipment of claim 14, wherein controlling said user equipment transmissions includes capping a transmit power level of the user equipment to a determined safe output power level in the event that it is determined that the safe output power level would be exceeded by implementing a transmit power control command received at the user equipment from the network node.

16. The user equipment of claim 14, wherein controlling said user equipment transmissions includes asking permission from the network node to adjust timings of one or more uplink transmissions of the user equipment.

17. The user equipment of claim 14, wherein controlling said user equipment transmission includes asking permission from the network node to control transmit power levels of said transmissions.

18. The user equipment of claim 14, wherein controlling said user equipment transmission includes asking permission from the network node to prioritise between at least one primary component carrier and one secondary component carrier.

19. The user equipment of claim 9, wherein the approval comprises an automatic approval to allow the user equipment to mitigate self-interference at the user equipment.

20. The user equipment of claim 9, wherein the multi-band operation as being one of inter-band carrier aggregation, CA, operation or dual connectivity, DC, operation.

21. (canceled)

22. A method, comprising:
transmitting, from a user equipment to a network node, an indication that the user equipment has the capability to mitigate self-interference at the user equipment for multi-band operation; and
receiving, at the user equipment from the network node, an approval to allow the user equipment to mitigate self-interference at the user equipment for the multi-band operation.

23-24. (canceled)
